(19) United States
(12) Patent Application Publication
(10) Pub. No.: US 2026/0025614 A1
(43) Pub. Date: Jan. 22, 2026

(54) ACOUSTIC OUTPUT DEVICES

(71) Applicant: SHENZHEN SHOKZ CO., LTD., Shenzhen (CN)

(72) Inventors: Chaojie CUI, Shenzhen (CN); Lei ZHANG, Shenzhen (CN)

(73) Assignee: SHENZHEN SHOKZ CO., LTD., Shenzhen (CN)

(21) Appl. No.: 19/340,980

(22) Filed: Sep. 26, 2025

Related U.S. Application Data
(63) Continuation of application No. PCT/CN2023/129868, filed on Nov. 6, 2023.

(51) Int. Cl. H04R 1/28; B06B 1/06; H04R 17/00

(52) U.S. Cl. CPC H04R 1/28; B06B 1/0651; H04R 17/00; H04R 2460/11

(57) ABSTRACT

Disclosed herein are an acoustic output device, including: a housing; a driving unit, the driving unit being accommodated in the housing, the driving unit vibrating to generate sound and outputting the sound through a sound outlet hole provided on the housing; a draining member provided at the sound outlet hole; and an ultrasound transmitting module configured to output an ultrasound excitation signal. The draining member includes an oscillation unit and a plurality of holes. The plurality of holes include a plurality of sound passage holes that allow sound transmission. And the oscillation unit is configured to generate an ultrasonic oscillation in response to the ultrasound excitation signal to discharge liquids at and near the sound passage holes.

### CROSS REFERENCE TO RELATED APPLICATIONS

The application is a continuation of International Application No. PCT/CN2023/129868, filed on Nov. 6, 2023, the contents of which are incorporated herein by reference.

### TECHNICAL FIELD

The present disclosure relates to the field of acoustics, and in particular to an acoustic output device.

### BACKGROUND

With the development of acoustic output technology, an acoustic output device (e.g., a headphone) has been widely used in people's daily lives. The acoustic output device may be provided with a hole (e.g., a sound outlet hole, a tuning hole, a pickup hole, etc.) to realize sound conduction. Due to the environment in which the acoustic output device is used, it is possible for the hole on the acoustic output device to be adhered to by liquids, such as water, sweat, and oil. The liquids may block the hole, damaging the internal components of the acoustic output device, seriously affecting the acoustic performance of the acoustic output device, and reducing the hearing quality of the user.

Therefore, it is necessary to propose the acoustic output device capable of conveniently removing liquids, such as water, sweat, and oil adhering to the hole, to ensure the acoustic performance of the acoustic output device and the hearing quality of the user.

### SUMMARY

Embodiments of the present disclosure provide an acoustic output device. The acoustic output device comprises: a housing; a driving unit, the driving unit being accommodated in the housing, the driving unit vibrating to generate sound and outputting the sound through a sound outlet hole provided on the housing; a draining member provided at the sound outlet hole; and an ultrasound transmitting module configured to output an ultrasound excitation signal; wherein the draining member includes an oscillation unit and a plurality of holes, the plurality of holes including a plurality of sound passage holes that allow sound transmission, and the oscillation unit is configured to generate an ultrasonic oscillation in response to the ultrasound excitation signal to discharge liquids at and near the sound passage hole.

In some embodiments, an aperture size of the sound passage hole is greater than or equal to 0.1 mm.

In some embodiments, the plurality of holes includes a plurality of atomizing holes, and along a thickness direction of the housing from an inside to an outside, an aperture size of each atomizing hole gradually decreases along an axis direction of the atomizing hole.

In some embodiments, a first opening of the atomizing hole proximate to the outside side of the housing has a first aperture size, and the first aperture size is in a range of 1 μm-15 μm.

In some embodiments, a second opening of the atomizing hole proximate to the inside of the housing has a second aperture size, and a ratio of the second aperture size to the first aperture size is in a range of 3-10.

In some embodiments, a distance between any one of the plurality of atomizing holes and its nearest sound passage hole is 10 μm-500 μm.

In some embodiments, for any one of the plurality of sound passage holes, a hole nearest to it is one of the plurality of atomizing holes.

In some embodiments, the plurality of sound passage holes are distributed in an annular array, and the plurality of atomizing holes are provided in an inner side of the annular array.

In some embodiments, on the draining member, an average amplitude of a region where the plurality of atomizing holes are set is greater than an average amplitude of the other regions.

In some embodiments, the plurality of atomizing holes have a total area of 3.5 kμm²-35kμm².

In some embodiments, on the draining member, an area of a region where the plurality of atomizing holes are set is 10 mm²-40 mm².

In some embodiments, a side of the draining member proximate to an inside of the housing is provided with hydrophobic material, and/or, the other side of the draining member proximate to an outside of the housing is provided with hydrophobic material.

In some embodiments, the oscillation unit includes a substrate layer and a piezoelectric layer partially covering the substrate layer, and the plurality of holes are provided in a region of the substrate layer that is not covered by the piezoelectric layer.

In some embodiments, the piezoelectric layer has an annular structure, and the plurality of holes are provided in an inner side of the annular structure.

In some embodiments, a thickness of the substrate layer is 0.05 mm-0.15 mm.

In some embodiments, a material of the substrate layer is an anti-corrosion metal.

In some embodiments, the oscillation unit includes a piezoelectric sheet, and the piezoelectric sheet is provided with the plurality of holes.

In some embodiments, the draining member further includes a substrate, the piezoelectric sheet is provided on the substrate, and the plurality of holes penetrate the substrate and the piezoelectric sheet.

In some embodiments, the acoustic output device further includes a liquid detection sensor, the liquid detection sensor is configured to: in response to detecting a liquid on the draining member, output a detection signal; and the ultrasound transmitting module is configured to: in response to receiving the detection signal output by the liquid detection sensor, output the ultrasound excitation signal.

In some embodiments, the ultrasound excitation signal is related to a state of the acoustic output device.

In some embodiments, when the acoustic output device is in an operating state, the ultrasound excitation signal has a first driving voltage; when the acoustic output device is in an idle state, the ultrasound excitation signal has a second driving voltage; and the first driving voltage is less than the second driving voltage.

In some embodiments, when the acoustic output device is in an operating state, the ultrasound excitation signal has a first frequency; when the acoustic output device is in an idle state, the ultrasound excitation signal has a second frequency; and the first frequency is less than the second frequency.

In some embodiments, the detection signal includes a volume of the liquid, and the ultrasound excitation signal is related to the volume of the liquid.

In some embodiments, when the volume of the liquid is less than or equal to a preset volume threshold, the ultrasound excitation signal has a third driving voltage; when the volume of the liquid is greater than the preset volume threshold, the ultrasound excitation signal has a fourth driving voltage; and the third driving voltage is less than the fourth driving voltage.

In some embodiments, when the volume of the liquid is less than or equal to the preset volume threshold, the ultrasound excitation signal has a third frequency; when the volume of the liquid is greater than the preset volume threshold, the ultrasound excitation signal has a fourth frequency; and the third frequency is less than the fourth frequency.

In some embodiments, the acoustic output device further includes a trigger module, the trigger module being configured to receive a user instruction; and the ultrasound transmitting module is configured to: based on the user instruction, output the ultrasound excitation signal.

In some embodiments, the ultrasound excitation signal is related to the user instruction.

In some embodiments, the user instruction includes a first instruction and a second instruction; when the user instruction outputs the first instruction, the ultrasound excitation signal has a fifth driving voltage; when the user instruction outputs the second instruction, the ultrasound excitation signal has a sixth driving voltage; and the fifth driving voltage is less than the sixth driving voltage.

In some embodiments, the user instruction includes a first instruction and a second instruction; when the user instruction outputs the first instruction, the ultrasound excitation signal has a fifth frequency; when the user instruction outputs the second instruction, the ultrasound excitation signal has a sixth frequency; and the fifth frequency is less than the sixth frequency.

In some embodiments, the first driving voltage, the third driving voltage, and the fifth driving voltage are 3-9V, and the second driving voltage, the fourth driving voltage, and the sixth driving voltage are 9-15 V.

In some embodiments, the first frequency, the third frequency, and the fifth frequency are 100 Hz-200 kHz, the second frequency, the fourth frequency, and the sixth frequency are 1 MHZ-3 MHZ.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a diagram illustrating an exemplary structure of an acoustic output device according to some embodiments of the present disclosure;

FIG. 2 is a diagram illustrating an exemplary module of an acoustic output device according to some embodiments of the present disclosure;

FIG. 3 is a schematic diagram illustrating an exemplary structure of an oscillation unit including a piezoelectric sheet according to some embodiments of the present disclosure;

FIG. 4 is a schematic diagram illustrating a structure of a draining member according to some embodiments of the present disclosure;

FIG. 5 is a schematic diagram illustrating a structure of a draining member according to yet other embodiments of the present disclosure;

FIG. 6A is a schematic diagram illustrating a distribution of a plurality of sound passage holes and a plurality of atomizing holes on a draining member according to some embodiments of the present disclosure;

FIG. 6B is a schematic diagram illustrating a distribution of a plurality of sound passage holes and a plurality of atomizing holes on a draining member according to some further embodiments of the present disclosure;

FIG. 6C is a schematic diagram illustrating a distribution of a plurality of sound passage holes and a plurality of atomizing holes on a draining member according to yet other embodiments of the present disclosure;

FIG. 7 is an exemplary flowchart illustrating a process for determining an ultrasound excitation signal according to some embodiments of the present disclosure;

FIG. 8 is an exemplary flowchart illustrating a process for determining an ultrasound excitation signal based on a state of an acoustic output device according to some embodiments of the present disclosure;

FIG. 9 is an exemplary flowchart illustrating a process for determining an ultrasound excitation signal based on a detection signal output by a liquid detection sensor according to some embodiments of the present disclosure; and

FIG. 10 is an exemplary flowchart illustrating a process for determining an ultrasound excitation signal based on a user instruction according to some embodiments of the present disclosure.

### DETAILED DESCRIPTION

In order to more clearly illustrate the technical solutions of the embodiments of the present disclosure, the accompanying drawings required to be used in the description of the embodiments will be briefly described below. Obviously, the accompanying drawings in the following description are only some examples or embodiments of the present disclosure, and it is possible for those of ordinary skill in the art to apply the present disclosure to other similar scenarios according to these drawings without creative labor. Unless obviously obtained from the context or the context illustrates otherwise, the same numeral in the drawings refers to the same structure or operation.

It should be understood that, as used herein, “system”, “device”, “unit,” and/or “module” are used herein as a way to distinguish between different components, elements, parts, sections, or assemblies at different levels. However, the words may be replaced by other expressions if other words accomplish the same purpose.

As shown in the present disclosure and the claims, unless the context clearly suggests an exception, the words “a”, “an”, “one”, and/or “the” do not refer specifically to the singular, but may also include the plural. In general, the terms “including” and “comprising” only suggest the inclusion of explicitly identified steps and elements that do not constitute an exclusive list, and the method or device may also include other steps or elements.

In the description of the present disclosure, it is to be understood that the terms “first”, “second”, “third”, “fourth”, etc. are used for descriptive purposes only, and are not to be understood as indicating or implying relative importance or implicitly specifying the number of technical features indicated. Thereby, the limitations “first”, “second”, “third”, and “fourth” may expressly or implicitly include at least one such feature. In the description of the present disclosure, “plurality” means at least two, e.g., two, three, or the like, unless explicitly and specifically limited otherwise.

In the present disclosure, unless otherwise expressly specified and limited, the terms “connection”, “fixing”, etc. are to be understood broadly. For example, the term “connection” may refer to a fixed connection, a detachable connection, or a one-piece connection; it may be a mechanical connection or an electrical connection; it may be a direct connection or an indirect connection through an intermediate medium; it may also refer to an internal communication between two components or an interaction relationship between two components, unless otherwise explicitly defined. For those of ordinary skill in the art, the specific meanings of the above terms in the present disclosure may be understood on a case-by-case basis.

Flowcharts are used in the present disclosure to illustrate operations performed by a system according to embodiments of the present disclosure. It should be appreciated that the preceding or following operations are not necessarily performed in an exact sequence. Instead, steps may be processed in reverse order or simultaneously. Also, it is possible to add other operations to these processes or remove an operation or operations from them.

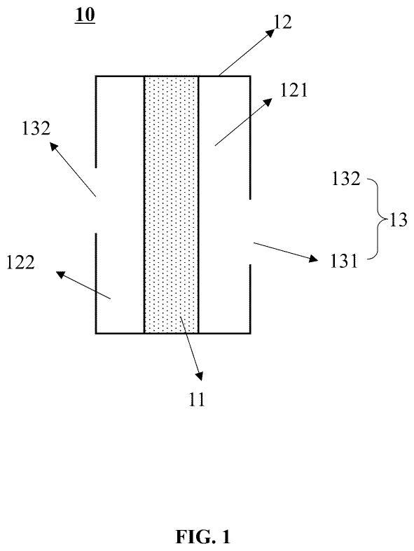

FIG. 1 is a diagram illustrating an exemplary structure of an acoustic output device according to some embodiments of the present disclosure. As shown in FIG. 1, the acoustic output device 10 may include a driving unit 11 and a housing 12.

In some embodiments, the acoustic output device 10 may include, but is not limited to, a bone conduction headphone, an air conduction headphone, a bone air conduction headphone, or the like. In some embodiments, the acoustic output device 10 may be an in-ear headphone, a semi-in-ear headphone, an open headphone, or the like. In some embodiments, the acoustic output device 10 may be combined with a product such as an eyeglass, a headphone, a head-mounted display device, an augmented reality/virtual reality (AR/VR) headphone, or the like.

A holding cavity may be formed within the housing 12 for accommodating the driving unit 11. For example, the housing 12 may be a rectangular, cylindrical, trapezoidal, L-shaped, U-shaped, V-shaped, or any irregularly shaped body and combinations thereof, and is not limited to shaped bodies shown in the drawings.

The driving unit 11 (e.g., a diaphragm) is used to convert an excitation signal (e.g., an electrical signal) into a corresponding mechanical vibration thereby producing sound. In some embodiments, the driving unit 11 is accommodated in the holding cavity of the housing 12, separating the holding cavity to form a front cavity 121 and a rear cavity 122 of the acoustic output device 10.

In some embodiments, the housing 12 is provided with a sound outlet hole 13. The sound outlet hole 13 is configured to output sound generated by the driving unit 11 out of the housing 12 and transmit the sound to an ear canal of a user, enabling the user to hear the sound. The sound outlet hole 13 may be provided with a draining member for draining fluid. In some embodiments, the sound outlet hole 13 may include at least one of a first sound outlet hole 131 or a second sound outlet hole 132. The first sound outlet hole 131 is acoustically coupled to the front cavity 121 and conducts sound generated by the front cavity 121 out of the housing 12 toward the ear canal. The second sound outlet hole 132 is acoustically coupled to the rear cavity 122 and conducts sound generated by the rear cavity 122 out of the housing 12. In some embodiments, first sound output by the first sound outlet hole 131 may be inversely phase canceled with second sound output by the second sound outlet hole 132 in a far field of the acoustic output device 10, which is conducive to reducing the leakage of the sound from the acoustic output device 10 in the far field. At this time, the acoustic output device 10 may include a semi-in-ear headphone or an open headphone. In some embodiments, the draining members may be provided at both the first sound outlet hole 131 and the second sound outlet hole 132.

In some embodiments, the second sound outlet hole 132 outputs the sound generated by the rear cavity 122, which may drain excess air pressure within the rear cavity 122 to balance air pressure within the acoustic output device 10. At this time, the acoustic output device 10 may include an in-ear headphone. In some embodiments, since the second sound outlet hole 132 is used for pressure relief, an aperture area of the second sound outlet hole 132 may be smaller than an aperture area of the first sound outlet hole 131, and the draining member may be provided at the first sound outlet hole 131 only.

In some embodiments, the acoustic output device 10 may be a bone conduction headphone, and the driving unit 11 may be configured to push a panel of the housing 12 to vibrate and transmit the vibration to skull of the user to produce the sound. At this time, the sound outlet hole 13 for outputting sound waves within the housing 12 may be provided in the housing 12 to offset sound leakage generated by the vibration of the housing 12 pushing air to reduce sound leakage from the acoustic output device 10. At this time, the draining member may be provided at the sound outlet hole 13.

In a use scenario of the acoustic output device 10, it is possible that the sound outlet hole 13 (including at least one of the first sound outlet hole 131 or the second sound outlet hole 132) may be adhered to liquids, causing blockage of the sound outlet hole 13, affecting the acoustic wave conduction of the sound outlet hole 13, and thus affecting the acoustic performance of the acoustic output device 10. For example, the liquids include rain, sweat, oil, and other common liquids in life. In some embodiments, the acoustic output device 10 includes the draining member for draining the liquids. The draining member is capable of generating an ultrasonic oscillation. The ultrasonic oscillation disrupts surface tension of the liquids, and ultrasonically atomizes the liquids adhered to the sound outlet hole 13, facilitating disengagement of the liquids from the sound outlet hole 13 to avoid the blockage of the sound outlet hole 13. In some embodiments, to discharge the liquids at the sound outlet hole 13 from the acoustic output device 10, avoid the liquids from entering into the acoustic output device 10 to damage components, and affect the working performance of the acoustic output device 10, a vibration direction of the draining member may be an axial direction along the sound outlet hole 13. That is, a direction of discharging the liquids may be along a thickness direction of the housing 12 from an inside to an outside, discharging the liquids from the inside of the housing 12. To further enhance the liquid discharge effect, the draining member may be provided with a guiding structure that restricts a flow direction of liquid droplets formed after the atomization, so as to promote the discharging of the liquids at the sound outlet hole 13 out of the acoustic output device 10, and to improve a liquid discharge rate. In some embodiments, the draining member may be disposed within the sound outlet hole 13.

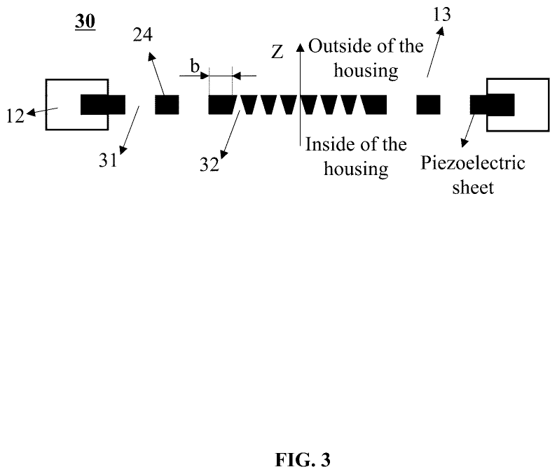

In some embodiments, the draining member includes an oscillation unit. The oscillation unit may receive an ultrasound excitation signal and generate the ultrasonic oscillation. The ultrasound excitation signal is output by an ultrasound transmitting module. In some embodiments, an oscillation amplitude generated by the oscillation unit is positively related to a voltage of the ultrasound excitation signal, and a count of times the oscillation unit completes periodic oscillation per unit of time (i.e., an oscillation frequency) is positively related to a frequency of the ultrasound excitation signal. In some embodiments, the higher the voltage or the frequency of the ultrasound excitation signal is, the higher the oscillation amplitude or the oscillation frequency of the oscillation unit is. The oscillation of the oscillation unit may ultrasonically atomize the liquids attached at the sound outlet hole 13. The oscillation amplitude and the oscillation frequency of the oscillation unit affect the effect of ultrasonic atomization. The effect of ultrasonic atomization may be characterized in terms of a droplet size and droplet density formed after atomization of the liquids. The oscillation amplitude of the oscillation unit is directly proportional to the droplet density formed by the atomization, i.e., the larger the amplitude, the larger the droplet density. The oscillation frequency of the oscillation unit is inversely proportional to the droplet size formed by the atomization, i.e., the higher the frequency, the smaller the droplet size. In some embodiments, the oscillation unit may be of a regular or irregular shape such as a ring, a rectangle, a circle, or the like. For more description of the draining member and its structure may be found elsewhere in the present disclosure, e.g., FIG. 3-FIG. 6C, etc. and the descriptions.

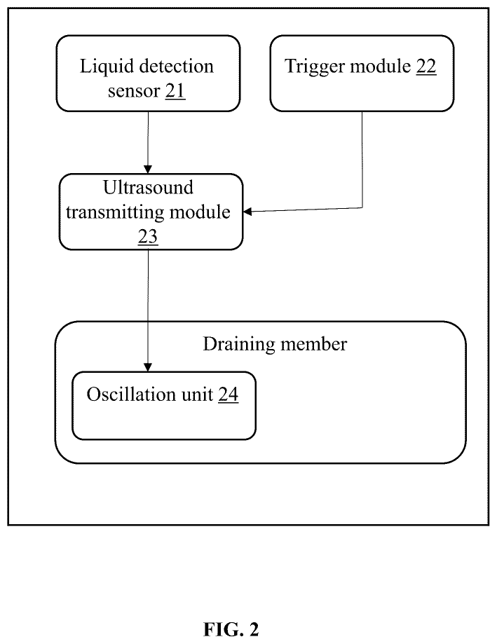

FIG. 2 is a diagram illustrating an exemplary module of an acoustic output device according to some embodiments of the present disclosure. As shown in FIG. 2, the acoustic output device 10 may include a liquid detection sensor 21, a trigger module 22, and an ultrasound transmitting module 23.

The liquid detection sensor 21 is configured to detect whether there is a liquid adhered at and near a draining member. In some embodiments, in response to the liquid detection sensor 21 detecting the liquid on the draining member, the liquid detection sensor 21 outputs a detection signal to the ultrasound transmitting module 23.

In some embodiments, the liquid detection sensor 21 may include a capacitive water droplet sensor. The capacitive water droplet sensor utilizes the property that a dielectric constant of the liquid is different from that of air and articles to detect the presence or absence of the liquid. The capacitive water droplet sensor may be a DS18B20 digital temperature sensor, a DHT11 temperature and humidity sensor, or the like. In some embodiments, the liquid detection sensor 21 may include a photoelectric water droplet sensor. The photoelectric water droplet sensor utilizes the photoelectric effect to detect the presence or absence of the liquid. When the liquid enters the photoelectric water droplet sensor, the liquid blocks the transmission of light as a means of detecting the presence of the liquid. The photoelectric water droplet sensor may be a water droplet sensor module YL-83, a TTP223 touch switch module, or the like. In some embodiments, the liquid detection sensor 21 may include a pressure water droplet sensor. The pressure water droplet sensor detects the presence or absence of the liquid through pressure changes. When the liquid drops into the pressure water droplet sensor, a certain pressure change occurs within the pressure water droplet sensor to detect the presence of the liquid. The pressure water droplet sensor may be a chip pressure sensor, a piezoelectric sensor, or the like.

In some embodiments, the acoustic output device may include a master control circuit. The liquid detection sensor 21 detects the liquid on the draining member, and transmits the detection signal to the master control circuit. The master control circuit then outputs a feedback signal to the ultrasound transmitting module 23, and the ultrasound transmitting module 23 transmits a corresponding ultrasound excitation signal based on the received feedback signal. In some embodiments, after the liquid detection sensor 21 detects the liquid on the draining member, the liquid detection sensor 21 may continuously transmit the detection signal to the master control circuit until the liquid detection sensor 21 detects that there is no liquid on the draining member (or a liquid parameter on the draining member satisfies a preset condition, for example, a volume of the liquid is less than a preset threshold, etc.), and then the master control circuit continuously outputs the feedback signal to the ultrasound transmitting module 23 until the detection signal stops being transmitted In some embodiments, after the liquid detection sensor 21 detects the liquid on the draining member, the liquid detection sensor 21 may continue to transmit the detection signal to the master control circuit for a preset duration. The preset duration may be set according to actual application requirements. For example, the preset duration may be set to 1s, 3s, or 5s, etc. When the preset duration has elapsed, the liquid detection sensor 21 may immediately stop outputting the detection signal.

The trigger module 22 is configured to receive a user instruction and output a control signal to the ultrasound transmitting module 23. In some embodiments, the user instruction may be input via the trigger module 22 when the user believes that the acoustic output device 10 needs to be drained. After the trigger module 22 receives the user instruction, the trigger module 22 outputs the control signal to the master control circuit, the master control circuit then outputs the feedback signal to the ultrasound transmitting module 23, and the ultrasound transmitting module 23 transmits the corresponding ultrasound excitation signal based on the feedback signal received. In some embodiments, the acoustic output device 10 is provided with a button as the trigger module 22, allowing the user to input the user instruction by long pressing, short pressing, continuously pressing, or touching the button. In some embodiments, the acoustic output device 10 is provided with a touch region as the trigger module 22, allowing the user to realize the input of the user instruction by operations such as clicking, double-clicking, swiping, or the like. The user instruction may be inputted into the acoustic output device 10 through various arbitrary ways or means. The description of the present disclosure using the button or the touch region as the trigger module 22 is for convenience of illustration only.

In some embodiments, the user instruction may include adjustment information for adjusting the ultrasound excitation signal. In some embodiments, the adjustment information includes adjusting a voltage and a frequency of the ultrasound excitation signal. In response to the adjustment of the voltage and the frequency of the ultrasound excitation signal, an amplitude and a frequency of an oscillation unit are adjusted to adjust liquid discharge intensity (i.e., atomization effect) of the draining member. The liquid discharge intensity of the draining member is positively related to an oscillation amplitude and an oscillation frequency of the draining member. Merely by way of example, when a user needs to autonomously control the draining of the fluid (e.g., after a swim), the user may press or touch the button on the acoustic output device 10 to input the user instruction and reflect the adjustment information by a length of time or a count of times the button (i.e., the trigger module 22) is pressed or touched. For example, the longer or the more times the button is pressed or touched, the higher the voltage and the frequency of the ultrasound excitation signal output by the ultrasound transmitting module 23, and the more intense the liquid discharge intensity of the draining member.

In some embodiments, the trigger module 22, after receiving the user instruction, may continuously output the control signal to the master control circuit. In some embodiments, the duration of the output signal of the trigger module 22 may be set according to the actual application requirements. For example, the duration may be set to 1s, 3s, or 5s, etc. When the duration has elapsed, the trigger module 22 immediately stops outputting the control signal. In some embodiments, when the liquid detection sensor 21 detects that there is no liquid on the draining member, the liquid detection sensor 21 outputs a stop instruction to the trigger module 22 through the master control circuit, and the trigger module 22 immediately stops outputting the control signal.

An oscillation unit 24 on the draining member generates an ultrasonic oscillation in response to the ultrasound excitation signal output by the ultrasound transmitting module 23. In some embodiments, the oscillation unit 24 may be a component that vibrates in high frequencies (e.g., 1 MHz-3 MHZ). In some embodiments, the oscillation unit 24 may include a piezoelectric material. An exemplary piezoelectric material may include a piezoelectric ceramic, a piezoelectric crystal, a piezoelectric polymer (e.g., vinylidene fluoride), etc., or any combination thereof. Due to the inverse piezoelectric effect of the piezoelectric material, when the ultrasound excitation signal (i.e., an electrical signal) is applied to the oscillation unit 24, the oscillation unit 24 generates a high-frequency mechanical vibration.

To ensure the working performance of the acoustic output device 10, and that the sound outlet hole 13 is capable of conducting acoustic waves, a plurality of holes are also provided on the draining member. When the oscillation unit 24 generates the ultrasonic oscillation in response to the ultrasound excitation signal, the oscillation unit 24 drives the draining member to vibrate, atomizing the liquid adhering to the holes, discharging the liquid at the sound outlet hole 13, and preventing the liquid from blocking the holes, which affects the sound transmission. In some embodiments, the draining member may fill the entire sound outlet hole to ensure the effect of discharging the liquid. In some embodiments, the sound outlet hole 13 (e.g., at least one of the first sound outlet hole 131 or the second sound outlet hole 132 shown in FIG. 1) penetrates the housing. Correspondingly, the sound outlet hole 13 has an aperture wall, and a peripheral side of the draining member may be connected to the aperture wall by one or a combination of ways such as a snap-fit, glue bond, or the like. In some embodiments, the draining member may have a substrate (not shown in the figures). The peripheral side of the substrate is connected to the aperture wall by one or a combination of ways such as a snap-fit, glue bonding, or the like. The oscillation unit 24 is provided on the substrate, and the substrate is provided in such a way as to enhance structural strength of the draining member. At this time, the substrate is provided with a plurality of holes, and the oscillation unit 24 may drive the substrate to vibrate to realize the discharging of the liquid. In some embodiments, the oscillation unit 24 may be directly used as the substrate of the draining member to simplify the structure of the draining member and reduce the cost of materials. At this time, the peripheral side of the oscillation unit 24 may be connected to the aperture wall, and the plurality of holes are provided on the oscillation unit 24. The following is an example of a structure in which the draining member does not include the substrate, and an explanation of vibratory liquid discharge of the draining member is provided.

FIG. 3 is a schematic diagram illustrating an exemplary structure of an oscillation unit including a piezoelectric sheet according to some embodiments of the present disclosure. In some embodiments, the oscillation unit 24 may include a piezoelectric sheet as a piezoelectric layer of the oscillation unit 24. A peripheral side of the piezoelectric sheet may be directly connected to an aperture wall of the sound outlet hole 13 on the housing 12, with a plurality of holes provided on the piezoelectric sheet. The piezoelectric sheet may include a piezoelectric material described above. The piezoelectric sheet may generate an ultrasonic oscillation in response to an ultrasound excitation signal to achieve a fluid discharge function. At this time, as an edge region of the piezoelectric sheet is connected to the aperture wall of the sound outlet hole, vibration of the edge region of the piezoelectric sheet is limited, and an amplitude of a central region of the piezoelectric sheet is larger, the plurality of holes may be provided in the central region of the piezoelectric sheet, as shown in FIG. 3.

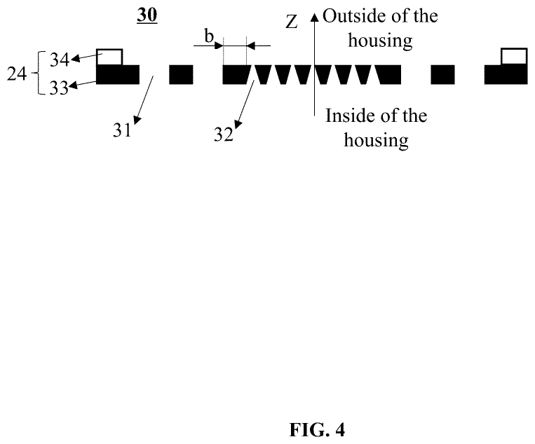

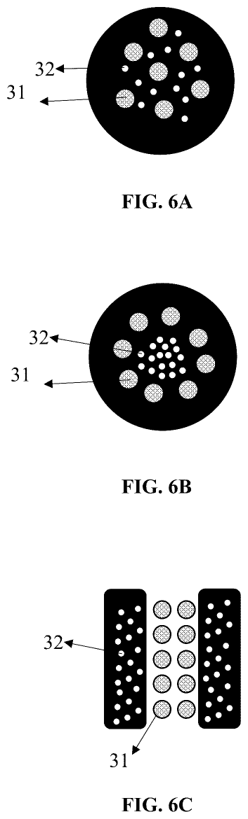

FIG. 4 is a schematic diagram illustrating a structure of a draining member according to some embodiments of the present disclosure. In some embodiments, as shown in FIG. 4, to avoid the connection of the oscillation unit 24 directly to an aperture wall affecting an oscillation frequency and an oscillation amplitude of the oscillation unit 24, the oscillation unit may include a substrate layer 33 and a piezoelectric layer 34. A peripheral side of the substrate layer 33 is connected to the aperture wall of a sound outlet hole, and the piezoelectric layer 34 is provided on the substrate layer 33. The piezoelectric layer 34 includes a piezoelectric material described above. The piezoelectric layer 34 drives the substrate layer 33 to perform an ultrasonic oscillation in response to an ultrasound excitation signal. In some embodiments, the shape of the piezoelectric layer 34 with a positional distribution on the substrate layer 33 may determine vibration amplitudes in different regions of the substrate layer 33, which in turn affects positions where the plurality of holes are provided on the substrate layer 33. In some embodiments, the plurality of holes may be disposed in regions on the substrate layer 33 that are not covered by the piezoelectric layer 34. For example, when the piezoelectric layer 34 is annular, the piezoelectric layer 34 may be disposed in an edge region near a peripheral side of the substrate layer 33. At this time, a central region of the substrate layer 33 has the largest average amplitude during the ultrasonic oscillation. Due to the influence of the connection with the aperture wall, an average amplitude of the substrate layer 33 decreases as it extends from the central region to the peripheral side, and the plurality of holes may be disposed on the region of the substrate layer 33 disposed on an inner side of the piezoelectric layer 34 to ensure vibration amplitudes at the plurality of holes, which may be described with reference to FIG. 6A, FIG. 6B, and related descriptions. As another example, when the piezoelectric layer 34 is a structure of a circle, an ellipse, a concave, convex polygon, etc., the piezoelectric layer 34 may be disposed in a central region of the substrate layer 33. At this time, when the substrate layer 33 is subjected to the ultrasonic oscillation driven by the piezoelectric layer 34, an average amplitude of a region between an edge region of the substrate layer 33 and the region covered by the piezoelectric layer 34 is larger, and an average amplitude of the edge region of the substrate layer 33 is smaller. At this time, the plurality of holes may be disposed in the region between the edge region of the substrate layer 33 and the region covered by the piezoelectric layer 34. Exemplarily, when the piezoelectric layer 34 is in a shape of a strip and is provided in the central region of the substrate layer 33, the piezoelectric layer 34 on the substrate layer 33 may be spaced apart from the plurality of holes to ensure that the plurality of holes may cover a larger vibration region, as described in FIG. 6C and related descriptions.

In some embodiments, when an area of the piezoelectric layer 34 is large (e.g., when the shape and the area of the piezoelectric layer 34 is the same as that of the substrate layer 33), an arca of a region on the substrate layer 33 that is not covered by the piezoelectric layer 34 is small, and the plurality of holes may be disposed in the region on the substrate layer 33 that is covered by the piezoelectric layer 34. At this time, the plurality of holes are provided in a manner similar to that described above when the oscillation unit 24 includes only the piezoelectric sheet, and the plurality of holes may penetrate both the substrate layer 33 and the piezoelectric layer 34.

In some embodiments, to ensure the average amplitude of the substrate layer 33, a thickness dimension of the substrate layer 33 along the Z direction shown in FIG. 4 should not be too large. However, considering the reliability of the substrate layer 33, the thickness dimension of the substrate layer 33 along the Z direction should not be too small. Thus, in some embodiments, a thickness of the substrate layer 33 along the Z-direction may range from 0.05 mm to 0.15 mm. In some embodiments, to increase the average amplitude of the substrate layer 33, the thickness of the substrate layer 33 along the Z direction may range from 0.05 mm to 0.12 mm. In some embodiments, to enhance the reliability of the substrate layer 33 and prolong the service life of the substrate layer 33, the thickness of the substrate layer 33 along the Z direction may range from 0.08 mm to 0.12 mm.

In some embodiments, since the draining member may be in frequent contact with slightly corrosive liquids (e.g., sweat), to ensure reliability of the draining member, a material of the substrate layer 33 may include an anti-corrosion metal, such as SUS304 stainless steel, etc.

In other embodiments, when the draining member includes the oscillation unit 24 and the substrate, setting relationship between the oscillation unit 24 and the substrate may be referenced to setting relationship between the piezoelectric layer 34 and the substrate layer 33 in the oscillation unit 24, and will not be repeated herein.

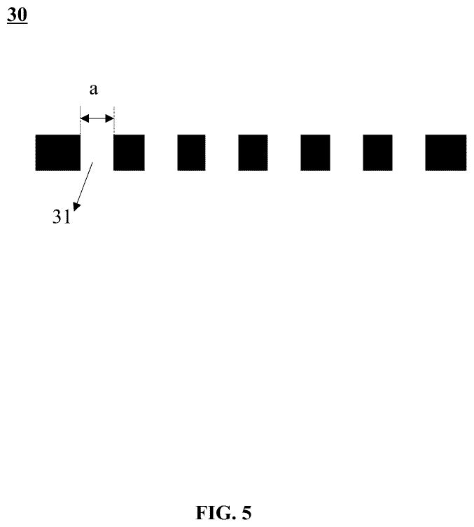

FIG. 5 is a schematic diagram illustrating a structure of a draining member according to yet other embodiments of the present disclosure. As shown in FIG. 5, a plurality of holes provided on the draining member 30 includes a plurality of sound passage holes 31.

The plurality of sound passage holes 31 are connected to the housing 12 from the inside to the outside of the acoustic output device 10, permitting the transmission of sound to ensure the output performance of the acoustic output device 10. In some embodiments, the plurality of sound passage holes 31 on the draining member 30 may interfere with, or even block, the transmission of sound when the plurality of sound passage holes 31 are adhered to or blocked by a liquid. When the draining member 30 is subjected to an ultrasonic oscillation driven by the oscillation unit 24, the liquid at and near the sound passage hole 31 undergoes ultrasonic atomization, which causes the liquid at and near the sound passage hole 31 to be discharged smoothly, thus preventing the liquid from blocking the sound passage hole 31. In some embodiments, near the sound passage hole 31 may refer to a region that is no more than 100 μm away from an aperture wall of the sound passage hole 31.

If an aperture size a (see FIG. 5) of the sound passage hole 31 is too small, the transmission of sound may be affected or even weakened. In some embodiments, to avoid that the aperture size of the sound passage hole 31 affects the transmission of sound, the aperture size a of the sound passage hole 31 is greater than or equal to 0.1 mm. If the aperture size a of the sound passage hole 31 is too large, a volume of the liquid adhered to the sound passage hole 31 is too large, which affects the atomization effect of the liquid and leads to poor discharge of the liquid in the sound passage hole 31. In some embodiments, to avoid that the aperture size of the sound passage hole 31 affects the atomization effect, the aperture size a of the sound passage hole 31 is not larger than 0.5 mm. In some embodiments, to avoid the aperture size of the sound passage hole 31 from affecting the transmission of sound and the atomization effect, the aperture size a of the sound passage hole 31 ranges from 0.1 mm to 0.5 mm. In some embodiments, to optimize the sounding effect of the sound passage hole 31, and at the same time to reduce the count of droplets being atomized into the inside of the acoustic output device 10, the aperture size a of the sound passage hole 31 ranges from 0.2 mm to 0.5 mm. In some embodiments, to further optimize the sounding effect of the sound passage hole 31, the aperture size a of the sound passage hole 31 ranges from 0.3 mm to 0.5 mm.

In some embodiments, when the draining member 30 undergoes the ultrasonic oscillation, the liquid inside the sound passage hole 31 undergoes ultrasonic atomization and is discharged from the sound passage hole 31. However, an atomized droplet may diffuse from the sound passage hole 31 into the inside of the housing 12 or may diffuse from the sound passage hole 31 to the outside of the housing 12. To avoid the liquid ingress inside the housing 12, the atomized droplet needs to be guided to be discharged as far as possible outside the housing 12. In some embodiments, the plurality of holes further include a plurality of atomizing holes 32 that guide droplets to discharge toward the outside of the housing 12.

In a thickness direction Z (see FIG. 4) of the housing 12 from the inside to the outside, an aperture size of each atomizing hole 32 gradually decreases along an axis direction of the atomizing hole, forming a cone structure. Within a micrometer-scale cone, the droplets spontaneously move toward an end with a smaller aperture size. Because of such self-transportability of the droplets, the atomized liquid droplets inside the atomizing hole 32 forming the cone structure will spontaneously move toward the end with the smaller aperture size to the outside of the housing 12.

In some embodiments, a dimension of the atomizing hole 32 needs to be maintained at a micron level to ensure the self-transportability of the droplets formed by atomization inside the atomizing hole 32. In some embodiments, the end of the smaller aperture size on the atomizing hole 32, i.e., a first opening on a side proximate to the outside of the housing 12, has a first aperture size. Taking into account the difficulty of machining the atomizing hole 32 on the draining member 30, the first aperture size is in a range of 1 μm-15 μm. In some embodiments, an end with a larger aperture size on the atomizing hole 32, i.e., a second opening on a side proximate to the inside of the housing, has a second aperture size. The dimension of the second aperture size is larger than the dimension of the first aperture size. In some embodiments, to maintain a taper of the cone structure formed by the atomizing hole 32 as a means to ensure the discharge effect of the atomized liquid droplets within the atomizing hole 32, a ratio of the second aperture size to the first aperture size is in a range of 3-10. Thereby, in some embodiments, the dimension of the second aperture size ranges from 3 μm to 150 μm. In some embodiments, to optimize the discharge effect of the atomized liquid droplets within the atomizing hole 32, the ratio of the second aperture size to the first aperture size is in a range of 5-10. In some embodiments, to further optimize the discharge effect of the atomized liquid droplets, the ratio of the second aperture size to the first aperture size is in a range of 5-8. In some embodiments, the atomizing hole 32 may be made by laser perforation.

In a daily operating scenario of the acoustic output device 10, the liquid that is exposed to a relatively high frequency at the sound outlet hole 13 generally includes water, and the draining member 30 may focus on additional design around waterproofing and drainage. In some embodiments, to further prevent water from entering the inside of the housing 12, a side of the draining member 30 proximate to the inside of the housing 12 is provided with hydrophobic material. In some embodiments, to facilitate the discharge of water within the atomizing hole 32 to the outside of the housing 12, a side of the draining member 30 proximate to the outside of the housing 12 is provided with hydrophobic material. In some embodiments, to enhance the waterproofing and draining effect of the draining member 30, it is possible to prevent water from entering the inside of the housing 12 while improving the ability to discharge water from the inside the housing 12 of the draining member 30. Specifically, the side of the draining member 30 proximate to the inside of the housing 12 is provided with the hydrophobic material, and the side of the draining member 30 proximate to the outside of the housing 12 is provided with the hydrophobic material. Exemplarily, the hydrophobic material may include, but is not limited to, Teflon (i.e., polytetrafluoroethylene), or the like.

In some embodiments, to reduce the processing difficulty of the draining member 30 and to reduce manufacturing cost, the draining member 30 may be provided with no atomizing holes 32. Instead, at least one of the aforementioned hydrophilic material or the hydrophobic material may be used alone to achieve a certain level of waterproofing. In some embodiments, to simplify a structure at the sound outlet hole 13 and reduce assembly difficulty, the draining member 30 may not be provided with at least one of the aforementioned hydrophilic material or the hydrophobic material. Instead, the atomizing holes 32 are used to achieve the liquid discharge effect. In some embodiments, to additionally obtain a better waterproof effect while having a better liquid discharge effect, the draining member 30 may be provided with at least one of the aforementioned hydrophilic material or the hydrophobic material while the atomizing holes 32 are provided.

In some embodiments, at least one of the hydrophilic material or the hydrophobic material may be covered around a position on the draining member 30 where the atomizing holes 32 are located, for example, by designing at least one of the hydrophilic material or the hydrophobic material in a shape of a ring so that the atomizing holes 32 are in an inner region of an annular structure to enhance the guidance of the atomizing holes 32 to the movement of water or water droplets formed by atomization towards the outside of the housing 12. In some embodiments, an aperture wall of the sound outlet hole is provided with the hydrophobic material, which is conducive to facilitating the discharge of water from the sound outlet hole, and at the same time reduces the adherence of water in the sound outlet hole. In some embodiments, the aperture wall of the sound outlet hole and inner and outer surfaces of the housing are provided with the hydrophobic material around the position where the sound outlet hole is located, which is conducive to facilitating the discharge of water to the outer surface of the housing, and at the same time reducing the adherence of water in the sound outlet hole.

In some embodiments, the sound passage hole 31 is configured to conduct sound to an ear canal of a user, and the atomizing hole 32 is configured to output the liquid to the outside of the housing 12. During an ultrasonic oscillation liquid discharge process of the draining member 30, the liquid (e.g., water) inside the sound passage hole 31 is atomized to form droplets, which simultaneously diffuse to both sides of the draining member 30 (i.e., the inside of the housing 12 and the outside of the housing 12). To reduce the droplets inside the housing 12, the atomizing hole 32 may be provided near the sound passage hole 31, and through a structure design and a hole position design of the atomizing hole 32, the self-transportability of the droplets is optimized, so as to discharge the droplets out of the housing 12. As the atomizing hole 32 itself is small in dimension, if a distance between the sound passage hole 31 and the atomizing hole 32 is too close to each other, it may lead to mutual influence when processing the sound passage hole 31 and the atomizing hole 32, which will increase the difficulty of the process. If the distance between the sound passage hole 31 and the atomizing hole 32 is too far apart, it may cause the atomizing hole 32 to be unable to contact and guide the atomized liquid droplets diffused from the sound passage hole 31 as much as possible to be discharged outwardly, thus affecting the liquid discharge effect. Accordingly, in some embodiments, a distance b (see FIG. 4) between any one of the plurality of atomizing holes 32 and its nearest sound passage hole 31 is 10 μm-500 μm. In some embodiments, to avoid damaging the atomizing hole 32 with a smaller dimension during processing of the sound passage hole 31, the distance b between any one of the plurality of atomizing holes 32 and its nearest sound passage hole 31 is 50 μm-500 μm. In some embodiments, to enable the atomizing hole 32 to attract more atomized liquid droplets diffused from the sound passage hole 31 to be discharged outwardly of the housing 12, the distance b between any one of the plurality of atomizing holes 32 and its nearest sound passage hole 31 is 50 μm-500 μm. Exemplary ways of distributing the sound passage hole 31, the atomizing hole 32 on the draining member 30 may be shown with reference to FIG. 6A-FIG. 6C. It should be noted that the above-mentioned distance b between the atomizing hole 32 and the sound passage hole 31 refers to a minimum distance between aperture walls of the two holes. That is to say, a line connecting a center of the atomizing hole 32 and a center of the sound passage hole 31 has an intersection with the aperture wall of the atomizing hole 32 and the aperture wall of the sound passage hole 31, respectively, and the distance between the two intersections is the minimum distance.

FIG. 6A is a schematic diagram illustrating a distribution of a plurality of sound passage holes and a plurality of atomizing holes on a draining member according to some embodiments of the present disclosure. FIG. 6B is a schematic diagram illustrating a distribution of a plurality of sound passage holes and a plurality of atomizing holes on a draining member according to some further embodiments of the present disclosure. FIG. 6C is a schematic diagram illustrating a distribution of a plurality of sound passage holes and a plurality of atomizing holes on a draining member according to yet other embodiments of the present disclosure. A shape of the draining member 30 shown in FIG. 6A and FIG. 6B is circular, and a shape of the draining member 30 shown in FIG. 6C is square.

As shown in FIG. 6A, the plurality of sound passage holes 31 and the plurality of atomizing holes 32 are staggeredly provided on the draining member 30, which facilitates the plurality of atomizing holes 32 to be able to uniformly adsorb and guide atomized liquid droplets diffused in the adjacent sound passage holes 31 to be discharged outwardly of the housing 12. In some embodiments, for any one of the plurality of sound passage holes 31, a hole nearest thereto is one of the plurality of atomizing holes 32. In some embodiments, at least one atomizing hole 32 is provided between any one of the plurality of sound passage holes 31 and any one of the other sound passage holes 31.

As shown in FIG. 6B, the plurality of sound passage holes 31 are distributed in an annular array, and the plurality of atomizing holes 32 are provided in an inner side of the annular array formed by the plurality of sound passage holes 31. That is, the plurality of atomizing holes 32 are centrally distributed, and the plurality of sound passage holes 31 are distributed around the atomizing holes 32, which may avoid mutual influences when processing the plurality of sound passage holes 31 and the plurality of atomizing holes 32. In some alternative embodiments, the plurality of atomizing holes 32 are distributed in an annular array, and the plurality of sound passage holes 31 are provided in an inner side of the annular array.

As shown in FIG. 6C, the plurality of sound passage holes 31 are centrally disposed, and the plurality of atomizing holes 32 are distributed on both sides of the plurality of sound passage holes 31. In some embodiments, to ensure that a distance between the sound passage holes 31 and the atomizing holes 32 is not too far, thereby maintaining the liquid discharge effect of the plurality of atomizing holes 32, the plurality of sound passage holes 31 are arranged in rows or columns, and the plurality of atomizing holes 32 are distributed on both sides of the sound passage holes 31. In some alternative embodiments, the plurality of atomizing holes 32 are centrally distributed, and the plurality of sound passage holes 31 are distributed on both sides of the plurality of atomizing holes 32. In some embodiments, the plurality of sound passage holes 31 and the plurality of atomizing holes 32 may be spaced apart in rows or columns. For example, in an array distribution of the sound passage holes 31 and the atomizing holes 32, odd-numbered rows or columns are occupied by the plurality of sound passage holes 31, while even-numbered rows or columns are occupied by the plurality of atomizing holes 32.

In some embodiments, an amplitude of each region on the draining member 30 may be different when the draining member 30 is subjected to an ultrasonic oscillation. The amplitude of each region on the draining member 30 may be obtained by comparing morphology of the draining member 30 at a position of maximum vibration with morphology when it is not vibrated (initial morphology). The morphology of the draining member 30 at the position of maximum vibration may be captured by a high-speed video camera by taking continuous pictures. The amplitude of each region on the draining member 30 is related to the oscillation unit 24 (e.g., a distribution pattern of a piezoelectric material on the oscillation unit 24). By designing the oscillation unit 24, the amplitude of each region on the draining member 30 may be regulated. The greater the vibration amplitude, the greater the density of the droplets formed after being atomized. At a certain frequency, dimensions of the droplets formed after being atomized is approximate or the same. Thus, the larger the vibration amplitude is, the more droplets are atomized, and the better the liquid discharge effect is. To enable more atomized liquid droplets to be exported to an outside of the housing 12 through the atomizing holes 32, the atomizing holes 32 may be provided in a position where has more atomized liquid droplets, that is, the atomizing holes 32 may be provided in a position of a region where the amplitude on the draining member 30 is larger. In some embodiments, an average amplitude of a region in which the atomizing hole 32 is located (i.e., the region in which the atomizing holes 32 are provided) may be greater than an average amplitude of the other regions.

In some embodiments, when the draining member 30 includes a substrate and the oscillation unit 24, the oscillation unit 24 may be an annular structure disposed on an edge region of the substrate near a peripheral side of the draining member 30. When the draining member 30 is subjected to the ultrasonic oscillation driven by the oscillation unit 24, the average amplitude of a central region of the draining member 30 is larger, and the average amplitude of the edge region of the draining member 30 is smaller. At this time, with reference to FIG. 6A, the plurality of sound passage holes 31 and the plurality of atomizing holes 32 are mixedly disposed in the central region of the draining member 30 (i.e., a region on the substrate layer 33 that is located in an inner side of the region covered by the piezoelectric layer 34 of the annular structure), at which time one of the plurality of atomizing holes 32 is disposed near any one of the plurality of sound passage holes 31, and the droplets inside the plurality of sound passage holes 31 are not easy to be retained. Or, referring to FIG. 6B, the plurality of atomizing holes 32 are centrally distributed in the central region of the draining member 30, and the plurality of sound passage holes 31 are distributed around the plurality of atomizing holes 32 between the edge region and the central region of the draining member 30. At this time, the average amplitude of the atomizing holes 32 is larger. A portion of the liquid droplets formed by atomization in the sound passage holes 31 that diffuses into the inside of the housing 12 is discharged to the outside of the housing 12 through the draining member 30 via the atomizing holes 32. At this time, the liquid discharge effect of the draining member 30 is relatively optimal.

In some embodiments, when the draining member 30 does not include the substrate, a peripheral side of the substrate layer 33 of the oscillation unit 24 may be fixed by connecting with an aperture wall of the sound outlet hole 13. The piezoelectric layer 34 of the oscillation unit 24 may be of an annular structure disposed on the edge region near the peripheral side of the substrate layer 33. The sound passage holes 31 and the atomizing holes 32 are provided directly on the central region of the substrate layer 33 of the oscillation unit 24. When the oscillation unit 24 performs the ultrasonic oscillation, the average amplitude of the central region is larger, and the average amplitude of the edge region proximate to the peripheral side is smaller. At this time, the distribution of the sound passage holes 31 and the atomizing holes 32 on the substrate layer 33 may be provided in the central region of the draining member 30 (i.e., the region on the substrate layer 33 that is located on the inside of the region covered by the piezoelectric layer 34 of the annular structure) in a mixed manner as shown in FIG. 6A. Or, as shown in FIG. 6B, the atomizing holes 32 are centrally distributed in the central region of the draining member 30, and the sound passage holes 31 are in the annular array distributed between a region where the atomizing holes 32 are provided and the region covered by the piezoelectric layer 34.

In some embodiments, when the draining member 30 includes the substrate and the oscillation unit 24, the oscillation unit 24 may be of a structure such as a circular, elliptical, concave/convex polygon, etc., and is provided in the central region of the draining member 30. When the draining member 30 is subjected to the ultrasonic oscillation driven by the oscillation unit 24, an average amplitude of the region between the edge region of the draining member 30 and the region covered by the oscillation unit 24 is larger, and an average amplitude of the edge region on the draining member 30 is smaller. At this time, the plurality of sound passage holes 31 are distributed centrally and correspondingly in the region covered by the oscillation unit 24, and the plurality of atomizing holes 32 are distributed in a peripheral region (e.g., in regions on both sides) of the oscillation unit 24 on the draining member 30. The droplets in the sound passage holes 31 are atomized and discharged to the outside of the housing 12 through the atomizing holes 32. Exemplarily, with reference to FIG. 6C, when the oscillation unit 24 is in a shape of a strip, the sound passage holes 31 may be distributed in rows or columns correspondingly concentrated within the region covered by the oscillation unit 24, while the atomizing holes 32 may be distributed in rows or columns on the regions on both sides of the oscillation unit 24.

In some embodiments, when the draining member 30 does not include the substrate, the peripheral side of the substrate layer 33 of the oscillation unit is connected to the aperture wall of the sound outlet holes to achieve fixation. The piezoelectric layer 34 of the oscillation unit may be of a structure such as circular, elliptical, concave/convex polygonal, etc., disposed in the central region of the substrate layer 33. When the substrate layer 33 is subjected to the ultrasonic oscillation driven by the piezoelectric layer 34, the average amplitude of the region between the edge region of the substrate layer 33 and the region covered by the piezoelectric layer 34 is larger, and the average amplitude of the edge region of the substrate layer 33 is smaller. At this time, the plurality of sound passage holes 31 are distributed centrally corresponding to the region covered by the piezoelectric layer 34, and the plurality of atomizing holes 32 are distributed in the peripheral region (e.g., the regions on both sides) of the piezoelectric layer 34 on the substrate layer 33. The droplets in the sound passage holes 31 are atomized and discharged to the outside of the housing 12 through the atomizing holes 32. Exemplarily, with reference to FIG. 6C, when the substrate layer 33 is in a shape of a strip, the sound passage holes 31 may be centrally distributed in rows or columns corresponding to the region covered by the piezoelectric layer 34, and the atomizing holes 32 may be distributed in rows or columns in the regions on both sides of the piezoelectric layer 34.

In some embodiments, the atomizing holes 32 should have a sufficient total area or count to ensure the effect of the atomizing holes 32 in discharging fluid outwardly of the housing 12. However, if the total area of the atomizing holes 32 is too large or the count of the atomizing holes 32 is excessive, it may result in an insufficient region on the drainage member 30 for arranging the sound passage holes 31, thereby affecting the sound transmission through the sound outlet hole 13. Therefore, in some embodiments, a count of the plurality of atomizing holes 32 is 500-2000. In some embodiments, the count of the plurality of atomizing holes 32 is 800-1800 to balance the liquid discharge effect of the draining member 30 with acoustic conduction needs of the sound outlet hole 13. In some embodiments, to further improve the fluid discharge effect of the draining member 30, the count of the plurality of atomizing holes 32 is 1000-1500. In some embodiments, the plurality of atomizing holes 32 have a total area of 3.5 kμm²-35 kμm² on a side of the draining member 30 near the inside of the housing 12. In some embodiments, to balance the liquid discharge effect of the draining member 30 with the acoustic conduction needs of the sound outlet hole 13, the plurality of atomizing holes 32 have a total area of 5.7 kμm²-32 kμm² on the side of the draining member 30 near the inside of the housing. In some embodiments, to further improve the liquid discharge effect of the draining member 30, the plurality of atomizing holes 32 have a total area of 7 kμm²-26 kμm² on the side of the draining member 30 near the inside of the housing.

In some embodiments, to ensure the liquid discharge effect of the draining member 30, an area of the region in which the atomizing holes 32 are provided and the total area of the draining member 30 should have a suitable ratio. If the ratio is too large, it may affect the structure strength of the draining member 30 and affect the sound emission effect of the sound outlet hole 13. If the ratio is too small, it may result in a region on the draining member 30 for discharging the liquid inside the housing 12 to the outside of the housing 12 being too small, affecting the liquid discharge performance of the draining member 30. To ensure the liquid discharge performance of the draining member 30 while not affecting the sound emission effect of the sound outlet hole 13, in some embodiments, the ratio of the area of the region in which the atomizing holes 32 are provided to the total area of the draining member 30 may be 0.05-0.2. Merely by way of example, similar to a structure shown in FIG. 6B, when the draining member 30 is a circular structure, a diameter of the draining member 30 may be about 16 mm, and an area of a region of the draining member 30 that is provided with the atomizing holes 32 is 10 mm²-40 mm². The area of the region in which the atomizing holes 32 are provided (i.e., the area of the region in which the atomizing holes 32 are provided on the draining member 30) may be an area of a region formed by a line connecting edges of a plurality of atomizing holes 32 located outermost among the plurality of atomizing holes 32; alternatively, it may be an area of the smallest circular region including the plurality of atomizing holes 32 (i.e., a circular region that is simultaneously tangent to two atomizing holes 32 that are farthest apart at the same time). It should be noted that the dimensions, areas and counts of the sound passage holes 31 and the atomizing holes 32 involved in the present disclosure may be actually measured by an industrial microscope.

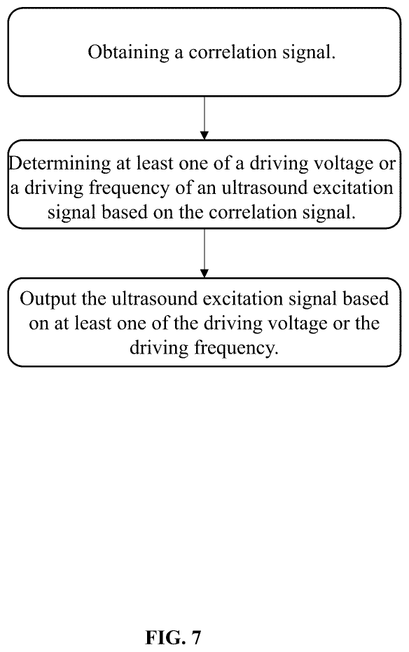

FIG. 7 is an exemplary flowchart illustrating a process for determining an ultrasound excitation signal according to some embodiments of the present disclosure.

As shown in FIG. 7, operations of determining the ultrasound excitation signal include: obtaining a correlation signal; determining, based on the correlation signal, at least one of a driving voltage or a driving frequency of the ultrasound excitation signal; and outputting the ultrasound excitation signal based on at least one of the driving voltage or the driving frequency.

The correlation signal refers to an electrical signal used to determine at least one of the driving voltage or the driving frequency of the ultrasound excitation signal. In some embodiments, the correlation signal includes an electrical signal sent by a liquid detection sensor or a user instruction. For example, the correlation signal may be a detection signal sent by the liquid detection sensor. The detection signal includes information such as whether a liquid is adhered, or a count of the liquid adhered. As another example, the correlation signal may be the user instruction, and the user instruction includes information such as adjusting liquid discharge intensity of a draining member. In some embodiments, the correlation signal may also be used to determine whether an acoustic output device needs to perform a fluid discharge process.

In some embodiments, based on different correlation signals, an ultrasound transmitting module determines at least one of the driving voltage or the driving frequency corresponding to the ultrasound excitation signal. Exemplarily, when the correlation signal corresponds to the acoustic output device not needing to be drained, at least one of the driving voltage or the driving frequency corresponding to the ultrasound excitation signal may be 0. When the correlation signal corresponds to the acoustic output device being drained at a lesser intensity, at least one of the driving voltage or the driving frequency corresponding to the ultrasound excitation signal may be smaller. When the correlation signal corresponds to the acoustic output device being drained at a larger intensity, at least one of the driving voltage or the driving frequency corresponding to the ultrasound excitation signal may be larger. In other embodiments, at least one of the driving voltage or the driving frequency of the ultrasound excitation signal corresponding to the different correlation signals may also be the same. For example, when the correlation signal is the detection signal sent by the liquid detection sensor, if data about the liquid in the detection signal satisfies a certain condition and it is determined that the acoustic output device does not need to perform liquid discharge, then based on different detection signals that satisfy the above conditions, at least one of the driving voltage or the driving frequency corresponding to the ultrasound excitation signal may be 0. As another example, different correlation signals corresponding to the detection signal and the user instruction may all correspond to a situation in which the acoustic output device discharges liquid with the same intensity. At this time, at least one of the driving voltage or the driving frequency corresponding to the ultrasound excitation signal may be the same based on the aforementioned different correlation signals.

In some embodiments, there is one or more oscillation modes (including at least one of a frequency or an amplitude) of the draining member. When there is a plurality of oscillation modes, based on the different correlation signals, the ultrasound transmitting module may determine at least one of different driving voltages or frequencies for the ultrasound excitation signals. For example, when the liquid detection sensor detects a larger amount of adhered liquid, the ultrasound transmitting module determines that at least one of the driving voltage or the driving frequency of the ultrasound excitation signal is larger, resulting in a larger liquid discharge intensity from the draining member. When the liquid detection sensor detects a smaller amount of adhered liquid, the ultrasound transmitting module determines that the at least one of the driving voltage or the driving frequency of the ultrasound excitation signal is smaller, resulting in a smaller liquid discharge intensity of the draining member. As another example, when the user instruction includes information to adjust the liquid discharge intensity of the draining member, the ultrasound transmitting module determines that at least one of the driving voltage or the driving frequency of the ultrasound excitation signal is adapted to the liquid discharge intensity of the draining member corresponding to the adjustment.

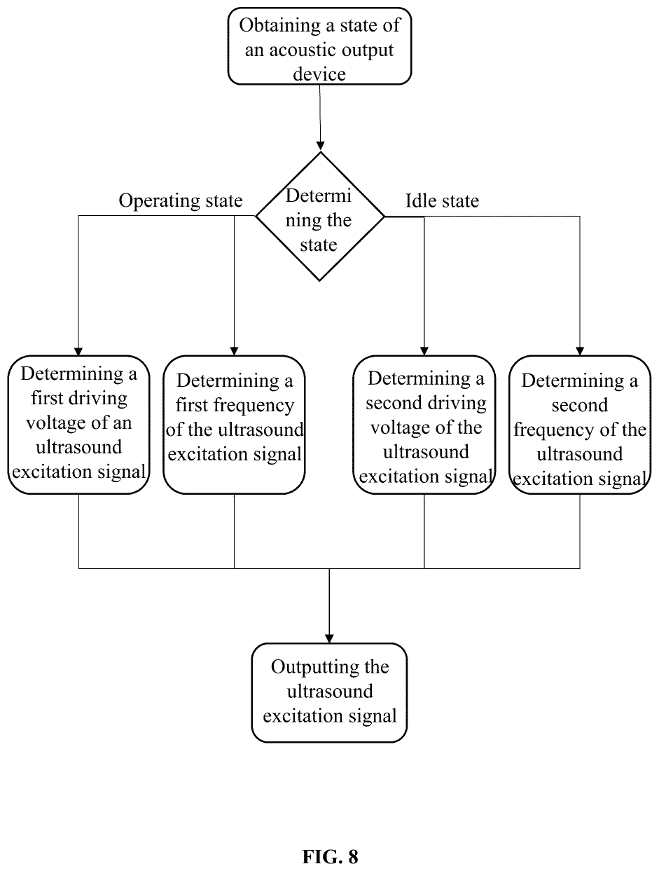

FIG. 8 is an exemplary flowchart illustrating a process for determining an ultrasound excitation signal based on a state of an acoustic output device according to some embodiments of the present disclosure. As shown in FIG. 8, at least one of a driving voltage or a driving frequency of the ultrasound excitation signal is determined based on the state of the acoustic output device.

When an acoustic output device is judged to be required to perform liquid discharge process based on a correlation signal, determining the ultrasound excitation signal based on the state of the acoustic output device may avoid the driving voltage of the required ultrasound excitation signal being too large and the driving frequency being too high, which results in power consumption of outputting the ultrasound excitation signal is too large, thus avoiding affecting operating performance of the acoustic output device.

In some embodiments, the state of the acoustic output device includes an operating state and an idle state. The operating state refers to a state in which the acoustic output device outputs sound. The idle state refers to a state in which the acoustic output device does not output sound. In some embodiments, an ultrasound transmitting module may obtain the state of the acoustic output device and determine whether the state of the acoustic output device is the operating state or the idle state. In some embodiments, the ultrasound transmitting module may obtain the state of the acoustic output device from a master control circuit. For example, the acoustic output device may be determined to be in the operating state when power consumption of the master control circuit is high, and the acoustic output device may be determined to be in the idle state when the power consumption of the master control circuit is low. In some embodiments, when the acoustic output device is judged to be in the operating state, the ultrasound transmitting module determines that the ultrasound excitation signal has a first driving voltage; when the acoustic output device is judged to be in the idle state, the ultrasound transmitting module determines that the ultrasound excitation signal has a second driving voltage. In some embodiments, since the acoustic output device is able to invoke more power for outputting the ultrasound excitation signal in the idle state than in the operating state, the first driving voltage is less than the second driving voltage.

Determining the ultrasound excitation signal based on the state of the acoustic output device includes: when the acoustic output device is judged to be in the operating state, decreasing the driving voltage of the ultrasound excitation signal to reduce an oscillation amplitude of an oscillation unit, thereby decreasing power consumption for discharging a liquid from a draining member; when the acoustic output device is in the idle state, increasing the driving voltage of the ultrasound excitation signal to increase the oscillation amplitude of the oscillation unit, thereby increasing a density of droplets formed by atomization of the draining member, so as to appropriately adjust the power consumption of the acoustic output device and ensure liquid discharge efficient of the draining member.

In some embodiments, when the acoustic output device is judged to be in the operating state, the ultrasound transmitting module determines that the ultrasound excitation signal has a first frequency; when the acoustic output device is judged to be in the idle state, the ultrasound transmitting module determines that the ultrasound excitation signal has a second frequency. In some embodiments, the first frequency is less than the second frequency due to the fact that the acoustic output device is able to call more power for outputting the ultrasound excitation signal in the idle state as compared to in the operating state.

Determining the ultrasound excitation signal based on the state of the acoustic output device, includes: when the acoustic output device is judged to be in the operating state, decreasing a frequency of the ultrasound excitation signal to decrease an oscillation frequency of the oscillation unit so as to decrease the power consumption for discharging the liquid from the draining member; when the acoustic output device is judged to be in the idle state, increasing the frequency of the ultrasound excitation signal to increase the oscillation frequency of the oscillation unit, thereby reducing dimensions of the droplets formed by the atomization of the draining member and improving the liquid discharge effect.

In other embodiments, when the acoustic output device is in the operating state, to enhance user experience, avoid blockage of a sound outlet hole, and ensure listening effect of a user, the first driving voltage and the first frequency of the ultrasound excitation signal may be relatively large to enhance the liquid discharge effect of the draining member; when the acoustic output device is in the idle state, the second driving voltage and the second frequency of the ultrasound excitation signal may be relatively small to save power consumption.

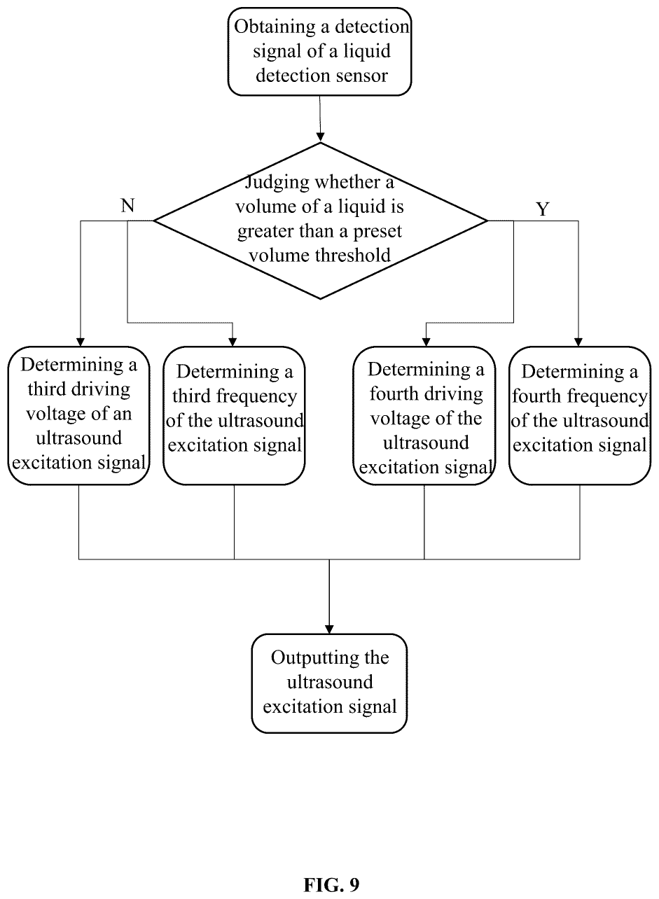

FIG. 9 is an exemplary flowchart illustrating a process for determining an ultrasound excitation signal based on a detection signal output by a liquid detection sensor according to some embodiments of the present disclosure. As shown in FIG. 9, a driving voltage and a driving frequency of the ultrasound excitation signal are determined based on the detection signal output by the liquid detection sensor.

In some embodiments, the liquid detection sensor may detect a volume of a liquid (i.e., liquid amount) present at a sound outlet hole, and the detection signal may include volumetric data of the liquid. In some embodiments, the ultrasound transmitting module is pre-stored with a first preset volume threshold and a second preset volume threshold. An ultrasound transmitting module receives the volume of the liquid sent by the liquid detection sensor and determines relationship between the volume of the liquid and the first preset volume threshold and the second preset volume threshold. In some embodiments, the volume of the liquid is less than or equal to the first preset volume threshold, indicating that the volume of the liquid is negligible, the acoustic output device does not need to carry out a liquid discharge process, and the ultrasound transmitting module determines that the driving voltage of the ultrasound excitation signal is 0. When the volume of the liquid is greater than the first preset volume threshold and less than the second preset volume threshold, it is indicated that the volume of the liquid is small, and that liquid discharge intensity of the required draining member is low, and the ultrasound transmitting module determines that the ultrasound excitation signal has a third driving voltage. When the volume of the liquid is greater than the second preset volume threshold, it is indicated that the volume of the liquid is larger, the liquid discharge intensity of the required draining member is higher, and the ultrasound transmitting module determines that the ultrasound excitation signal has a fourth driving voltage. The third driving voltage is less than the fourth driving voltage.

Determining the ultrasound excitation signal based on the volume of the liquid detected by the liquid detection sensor, includes: when the volume of the liquid detected by the liquid detection sensor is larger, the liquid discharge intensity of the required draining member is higher, correspondingly increasing the driving voltage of the ultrasound excitation signal to increase the oscillation amplitude of the oscillation unit; when the volume of the liquid detected by the liquid detection sensor is small, the liquid discharge intensity of the required draining member is low, reducing the driving voltage of the ultrasound excitation signal accordingly to reduce the oscillation amplitude of the oscillation unit. The foregoing operation allows for a more reasonable use and distribution of power consumption of the acoustic output device, avoiding a meaningless waste of power consumption.

In some embodiments, when the volume of the liquid is less than or equal to the first preset volume threshold, indicating that the volume of the liquid may be ignored, the acoustic output device does not need to carry out the liquid discharge process, and the ultrasound transmitting module determines that the driving frequency of the ultrasound excitation signal is 0. When the volume of the liquid is greater than the first preset volume threshold and less than the second preset volume threshold, it is indicated that the volume of the liquid is small, the liquid discharge intensity of the required draining member is low, and the ultrasound transmitting module determines that the ultrasound excitation signal has a third frequency. When the volume of the liquid is greater than the second preset volume threshold, it is indicated that the volume of the liquid is larger, the liquid discharge intensity of the required draining member is higher, and the ultrasound transmitting module determines that the ultrasound excitation signal has a fourth frequency. The third frequency is less than the fourth frequency.

Determining the ultrasound excitation signal based on the volume of the liquid detected by the liquid detection sensor, includes: when the volume of the liquid detected by the liquid detection sensor is larger, the liquid discharge intensity of the required draining member is higher, correspondingly increasing the driving frequency of the ultrasound excitation signal to increase the oscillation frequency of the oscillation unit; when the volume of the liquid detected by the liquid detection sensor is small, the liquid discharge intensity of the required draining member is low, reducing the driving frequency of the ultrasound excitation signal accordingly to reduce the oscillation frequency of the oscillation unit. The foregoing operation allows for a more reasonable use and distribution of power consumption of the acoustic output device, avoiding a meaningless waste of power consumption.

It is to be understood that determining the ultrasound excitation signal based on the volume of liquid detected by the liquid detection sensor is only intended as an example. In other embodiments, the ultrasound excitation signal may be determined based on other types of data detected by the liquid detection sensor. For example, the liquid detection sensor may detect a liquid intake rate or a continuous intake duration. Correspondingly, the detection signal sent by the liquid detection sensor may include data corresponding to the liquid-related data described above. The ultrasound transmitting module may determine the liquid discharge intensity of the required draining member based on the liquid-related data detected by the liquid detection sensor, to determine the driving voltage and the driving frequency of the ultrasound excitation signal.

Exemplarily, when the liquid detection sensor detects the continuous intake duration of the liquid (e.g., a pressure sensor detects a duration of pressure), the ultrasound transmitting module may be pre-stored with a first preset time threshold and a second preset time threshold. The ultrasound transmitting module receives the continuous intake duration of the liquid sent by the liquid detection sensor and determines relationship between the continuous intake duration and the first preset time threshold and the second preset time threshold. In some embodiments, when the continuous intake duration of the liquid is less than or equal to the first preset time threshold, it indicates that the volume of the liquid that enters the acoustic output device is very small and may be ignored, there is no need for the acoustic output device to carry out the liquid discharge process, and the ultrasound transmitting module determines that the driving voltage or the driving frequency of the ultrasound excitation signal is 0. When the continuous intake duration of the liquid is greater than the first preset time threshold and less than the second preset time threshold, it indicates that the liquid entering the acoustic output device is less and the liquid discharge intensity of the required draining member is lower, the ultrasound transmitting module determines that the ultrasound excitation signal has the third driving voltage or the third frequency. When the continuous intake duration of the liquid is greater than the second preset time threshold, it indicates that the volume of the liquid entering the acoustic output device is larger, and the liquid discharge intensity of the required draining member is higher, and the ultrasound transmitting module determines that the ultrasound excitation signal has the fourth driving voltage or the fourth frequency. The third driving voltage or the third frequency is less than the fourth driving voltage or the fourth frequency.

In other embodiments, determining the ultrasound excitation signal based on the state of the acoustic output device and determining the ultrasound excitation signal based on the volume of the liquid detected by the liquid detection sensor may be combined. For example, the state of the acoustic output device may be determined before determining whether the volume of the liquid is greater than a preset volume threshold. When determining that the acoustic output device is in the operating state, the volume of the liquid is less than or equal to the preset volume threshold, the ultrasound transmitting module determines that the ultrasound excitation signal has a driving voltage of A or a driving frequency of A, the volume of the liquid is greater than the preset volume threshold, the ultrasound transmitting module determines that the ultrasound excitation signal has a driving voltage of B or a driving frequency of B. The driving voltage of A is less than the driving voltage of B, or the driving frequency of A is less than the driving frequency of B. When determining that the acoustic output device is in the idle state, the volume of the liquid is less than or equal to the preset volume threshold, the ultrasound transmitting module determines that the ultrasound excitation signal has a driving voltage of C or a driving frequency of C, the volume of the liquid is greater than the preset volume threshold, the ultrasound transmitting module determines that the ultrasound excitation signal has a driving voltage of D or a driving frequency of D. The driving voltage of C is less than the driving voltage of D, or the driving frequency of C is less than the driving frequency of D. Meanwhile, the driving voltage of A is less than the driving voltage of C, or the driving frequency of A is less than the driving frequency of C, and the driving voltage of B is less than the driving voltage of D, or the driving frequency of B is less than the driving frequency of D.

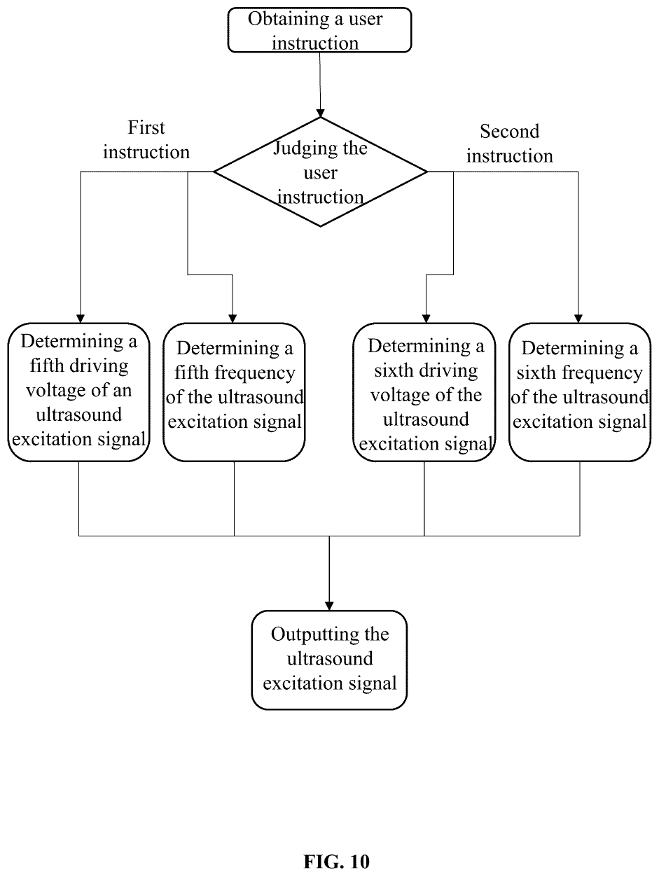

FIG. 10 is an exemplary flowchart illustrating a process for determining an ultrasound excitation signal based on a user instruction according to some embodiments of the present disclosure. As shown in FIG. 10, a driving voltage and a driving frequency of the ultrasound excitation signal are determined based on the user instruction.

In some embodiments, the user instruction may indicate whether to perform a drain on a draining member or the liquid discharge intensity of the draining member. In some embodiments, the fluid discharge intensity is positively related to a frequency and an amplitude of an oscillation unit.

In some embodiments, a trigger module may obtain the user instruction and determine a type of the user instruction. In some embodiments, the user instruction includes a first instruction and a second instruction. The first instruction directs a lower intensity of discharge of the draining member and the second instruction directs a higher intensity of discharge of the draining member. In some embodiments, when the trigger module transmits, and an ultrasound transmitting module receives the first instruction, the ultrasound transmitting module determines that the ultrasound excitation signal has a fifth driving voltage. When the trigger module transmits, and the ultrasound transmitting module receives the second instruction, the ultrasound transmitting module determines that the ultrasound excitation signal has a sixth driving voltage. The fifth driving voltage is less than the sixth driving voltage.

The driving voltage of the ultrasound excitation signal is adjusted based on different intensities of the discharge requested by a user. When the liquid discharge intensity requested by the user is low, the driving voltage of the ultrasound excitation signal is reduced to reduce an oscillation amplitude of the oscillation unit, thereby reducing the density of droplets formed by atomization of the draining member. When the liquid discharge intensity requested by the user is high, the driving voltage of the ultrasound excitation signal is increased to increase the oscillation amplitude of the oscillation unit to increase the density of the droplets formed by atomization of the draining member.

In some embodiments, when the trigger module transmits, and the ultrasound transmitting module receives the first instruction, the ultrasound transmitting module determines that the ultrasound excitation signal has a fifth frequency. When the trigger module sends, and the ultrasound transmitting module receives the second instruction, the ultrasound transmitting module determines that the ultrasound excitation signal has a sixth frequency. The fifth frequency is less than the sixth frequency.

The driving frequency of the ultrasound excitation signal is adjusted based on the different intensities of the discharge requested by the user. When the liquid discharge intensity requested by the user is low, the driving frequency of the ultrasound excitation signal is decreased to decrease the oscillation frequency of the oscillation unit, thereby increasing the dimensions of the droplets formed by atomization of the draining member. When the liquid discharge intensity requested by the user is high, the driving frequency of the ultrasound excitation signal is increased to increase the oscillation frequency of the oscillation unit, thereby decreasing the dimensions of the droplets formed by atomization of the draining member.

In some embodiments, a first driving voltage, a third driving voltage, and the fifth driving voltage of the ultrasound excitation signal illustrated in FIGS. 8-10 may be the same, and are all 3-9 V. In some embodiments, driving voltages of the ultrasound excitation signals determined based on different judgment factors may also be different. Exemplarily, when the acoustic output device is in an operating state, the first driving voltage of the ultrasound excitation signal may be 3-6 V. When a volume of a liquid detected by the liquid detection sensor is less than or equal to a preset volume threshold value, the third driving voltage of the ultrasound excitation signal may be 3-8 V. The fifth driving voltage of the ultrasound excitation signal may be adapted to the user instruction. In some embodiments, a second driving voltage, a fourth driving voltage, and the sixth driving voltage of the ultrasound excitation signal shown in FIGS. 8-10 may be the same, and all be 9-15 V. In some embodiments, the driving voltages of the ultrasound excitation signals determined based on different judgment factors may also be different. Exemplarily, when the acoustic output device is in an idle state, the second driving voltage of the ultrasound excitation signal may be 10-13 V. When the volume of the liquid detected by the liquid detection sensor is greater than the preset volume threshold, the fourth driving voltage of the ultrasound excitation signal may be 12-15 V. The sixth driving voltage of the ultrasound excitation signal may be adapted to the user instruction.

In some embodiments, a first frequency, a third frequency, and the fifth frequency of the ultrasound excitation signal illustrated in FIGS. 8-10 may be the same, and all be 100 Hz-200 kHz. In some embodiments, driving frequencies of the ultrasound excitation signals determined based on different judgment factors may also be different. Exemplarily, when the acoustic output device is in the operating state, the first frequency of the ultrasound excitation signal may be 100 Hz-100 kHz; when the volume of the liquid detected by the liquid detection sensor is less than or equal to the preset volume threshold, the third frequency of the ultrasound excitation signal may be 500 Hz-200 kHz. The fifth frequency of the ultrasound excitation signal may be adapted to the user instruction. In some embodiments, a second frequency, a fourth frequency, and the sixth frequency of the ultrasound excitation signal illustrated in FIGS. 8-10 may be the same, and all be 1 MHZ-3 MHz. In some embodiments, the driving frequencies of the ultrasound excitation signals determined based on different judgmental factors may also be different. Exemplarily, when the acoustic output device is in the idle state, the second frequency of the ultrasound excitation signal may be 1.5 MH2-2 MHz; when the volume of the liquid detected by the liquid detection sensor is greater than the preset volume threshold, the fourth frequency of the ultrasound excitation signal may be 1.5 MHz-2.5 MHz. The sixth frequency of the ultrasound excitation signal may be adapted to the user instruction.

The basic concepts have been described above, and it will be apparent to those skilled in the art that the foregoing detailed disclosure serves only as an example and does not constitute a limitation of the present application. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. As in ‘an embodiment’, ‘one embodiment’, and/or ‘some embodiments’ means a feature, structure, or characteristic associated with at least one embodiment of the present application. Accordingly, it should be emphasized and noted that two or more references to ‘an embodiment’ or ‘one embodiment’ or ‘an alternative embodiment’ in different positions in the present disclosure do not necessarily refer to the same embodiment. In addition, some features, structures, or characteristics in the present disclosure of one or more embodiments may be appropriately combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

Some embodiments use numbers describing a count of components and attributes, and it should be understood that such numbers used in the description of the embodiments may, in some instances, be modified by terms such as ‘approximately’, ‘substantially’, or ‘about’. Unless otherwise noted, the terms ‘approximately’, ‘substantially’, or ‘about’ indicate that a ±20% variation in the stated number is allowed. Correspondingly, in some embodiments, the numerical parameters used in the present disclosure and claims are approximations, which can change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present application are approximations, in specific embodiments such values are set to be as precise as possible within a feasible range.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. An acoustic output device, comprising:
a housing;
a driving unit, the driving unit being accommodated in the housing, the driving unit vibrating to generate sound and outputting the sound through a sound outlet hole provided on the housing;
a draining member provided at the sound outlet hole; and
an ultrasound transmitting module configured to output an ultrasound excitation signal; wherein
the draining member includes an oscillation unit and a plurality of holes, the plurality of holes including a plurality of sound passage holes that allow sound transmission, and the oscillation unit is configured to generate an ultrasonic oscillation in response to the ultrasound excitation signal to discharge liquids at and near the sound passage holes.

2. (Canceled)

3. The acoustic output device of claim 1, wherein the plurality of holes includes a plurality of atomizing holes, and along a thickness direction of the housing from an inside to an outside, an aperture size of each atomizing hole gradually decreases along an axis direction of the atomizing hole.

4. The acoustic output device of claim 3, wherein a first opening of the atomizing hole proximate to the outside of the housing has a first aperture size, and the first aperture size is in a range of 1 μm-15 μm.

5. The acoustic output device of claim 4, wherein a second opening of the atomizing hole proximate to the inside of the housing has a second aperture size, and a ratio of the second aperture size to the first aperture size is in a range of 3-10.

6. The acoustic output device of claim 3, wherein a distance between any one of the plurality of atomizing holes and its nearest sound passage hole is 10 μm-500 μm.

7. The acoustic output device of claim 3, wherein, for any one of the plurality of sound passage holes, a hole nearest to it is one of the plurality of atomizing holes.

8. The acoustic output device of claim 3, wherein the plurality of sound passage holes are distributed in an annular array, and the plurality of atomizing holes are provided in an inner side of the annular array.

9. The acoustic output device of claim 3, wherein on the draining member, an average amplitude of a region where the plurality of atomizing holes are set is greater than an average amplitude of the other regions.

10. The acoustic output device of claim 3, wherein the plurality of atomizing holes have a total area of 3.5 kμm²-35 kμm².

11. The acoustic output device of claim 10, wherein on the draining member, an area of a region where the plurality of atomizing holes are set is 10 mm²-40 mm².

12. The acoustic output device of claim 1, wherein a side of the draining member proximate to an inside of the housing is provided with hydrophobic material, and/or, the other side of the draining member proximate to an outside of the housing is provided with hydrophobic material.

13. The acoustic output device of claim 1, wherein the oscillation unit includes a substrate layer and a piezoelectric layer partially covering the substrate layer, and the plurality of holes are provided in a region of the substrate layer that is not covered by the piezoelectric layer.

14. The acoustic output device of claim 13, wherein the piezoelectric layer has an annular structure, and the plurality of holes are provided in an inner side of the annular structure.

15-16. (Canceled)

17. The acoustic output device of claim 1, wherein the oscillation unit includes a piezoelectric sheet, and the piezoelectric sheet is provided with the plurality of holes.

18. The acoustic output device of claim 17, wherein the draining member further includes a substrate, the piezoelectric sheet is provided on the substrate, and the plurality of holes penetrate the substrate and the piezoelectric sheet.

19. The acoustic output device of claim 1, wherein the acoustic output device further includes a liquid detection sensor, the liquid detection sensor is configured to: in response to detecting a liquid on the draining member, output a detection signal; and the ultrasound transmitting module is configured to: in response to receiving the detection signal output by the liquid detection sensor, output the ultrasound excitation signal.

20. The acoustic output device of claim 19, wherein the ultrasound excitation signal is related to a state of the acoustic output device;
when the acoustic output device is in an operating state, the ultrasound excitation signal has a first driving voltage; when the acoustic output device is in an idle state, the ultrasound excitation signal has a second driving voltage; and the first driving voltage is less than the second driving voltage.

21-22. (Canceled)

23. The acoustic output device of claim 19, wherein the detection signal includes a volume of the liquid, and the ultrasound excitation signal is related to the volume of the liquid; wherein
the volume of the liquid is less than or equal to a preset volume threshold, the ultrasound excitation signal has a third driving voltage; when the volume of the liquid is greater than the preset volume threshold, the ultrasound excitation signal has a fourth driving voltage; and the third driving voltage is less than the fourth driving voltage.

24-25. (Canceled)

26. The acoustic output device of claim 1, wherein the acoustic output device further includes a trigger module, the trigger module being configured to receive a user instruction; and the ultrasound transmitting module is configured to: based on the user instruction, output the ultrasound excitation signal.

27. The acoustic output device of claim 26, wherein the ultrasound excitation signal is related to the user instruction;
the user instruction includes a first instruction and a second instruction; when the user instruction outputs the first instruction, the ultrasound excitation signal has a fifth driving voltage; when the user instruction outputs the second instruction, the ultrasound excitation signal has a sixth driving voltage; and the fifth driving voltage is less than the sixth driving voltage.

28-31. (Canceled)
